(19) United States
(12) Patent Application Publication
(10) Pub. No.: US 2026/0196040 A1
(43) Pub. Date: Jul. 9, 2026

(54) MULTIMODAL CLASSIFICATION OF VIDEO DATA

(71) Applicant: Lemon Inc., Grand Cayman (KY)

(72) Inventors: Wei YANG, Culver City, CA (US); Jiachen SUN, Culver City, CA (US); Xinghai HU, Culver City, CA (US)

(21) Appl. No.: 19/009,810

(22) Filed: Jan. 3, 2025

(51) Int. Cl. G06V 20/40; G06F 16/75; G06V 10/764; G06V 10/774

(52) U.S. Cl. CPC G06V 20/41; G06F 16/75; G06V 10/764; G06V 10/774; G06V 20/46

(57) ABSTRACT

A computing system for multimodal classification of video data includes processing circuitry that implements a video data classification program configured to perform classification tasks in a plurality of classification categories. In an inference phase, the processing circuitry receives video data to be classified according to a selected classification category of the plurality of classification categories and extracts a plurality of frames and corresponding text features from the video data. A classification model selection engine is implemented to select a multimodal classification model from a library of multimodal classification models based on the selected classification category. The selected multimodal classification model is queried with a prompt to classify the plurality of frames and the corresponding text features according to the selected classification category. The processor receives a prediction score from the selected multimodal classification model, indicating whether the video data includes content in the selected classification category.

### BACKGROUND

Multimodal classification models receive input from multiple data sources, such as images, audio, and text, to provide more accurate and context-aware predictions. Large language models are pretrained on large-scale, diverse datasets and have recently been implemented as a solution to classification tasks typically addressed by multimodal architectures. However, because such models are trained on public datasets, they lack the ability to capture the nuances of entity-specific policies. As a result, an entity desiring to classify video content using a generic multimodal language model based on its proprietary policies might experience unacceptably high misclassification rates. As one particular example, an entity may desire to assign video quality categories to user-generated content on a video sharing platform, to identify and remove videos of low quality, thereby promoting the quality of video content on the platform. Misclassification errors using a generic multimodal language model can result in undesirably low quality videos on the platform, degrading the user experience. In view of challenges such as these, opportunities remain for improvements in multimodal classification of video data.

### SUMMARY

In view of these issues, computing systems and methods for multimodal classification of video data are provided. In one aspect, the computing system includes processing circuitry configured to execute instructions using portions of associated memory to implement a video data classification program configured to perform classification tasks in a plurality of classification categories. In an inference phase, the processing circuitry is configured to receive video data to be classified according to a selected classification category of the plurality of classification categories and extract a plurality of frames and corresponding text features from the video data. A classification model selection engine is implemented to select a multimodal classification model from a library of multimodal classification models based on the selected classification category. The selected multimodal classification model is queried with a prompt to classify the plurality of frames and the corresponding text features according to the selected classification category. The processor receives a response from the selected multimodal classification model, which includes a prediction score indicating a likelihood that the plurality of frames and the corresponding text features includes content in the selected classification category.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of a computing system for multimodal classification of video data in an inference phase, according to one embodiment of the present disclosure.

FIG. 2 shows a schematic view of a computing system of FIG. 1 in a configuration phase.

FIG. 3 shows a schematic view of a computing system of FIG. 1 in a training phase.

FIG. 4 shows a flow diagram of method for multimodal classification of video data for the computing system of FIG. 1.

FIG. 5 shows a block diagram of an example computing system that may be utilized to implement the computing system of FIG. 1.

### DETAILED DESCRIPTION

Recognition over multi-modalities has become an increasingly critical challenge for large video platform companies, which rely on managing vast amounts of user-generated content. Unlike traditional classification tasks that process single-modality inputs, multimodal classification combines multiple data sources, such as image, audio, and text, to provide more accurate and context-aware predictions. The ability to reason across different modalities is essential for effective content moderation. This capability is particularly important for identifying inappropriate content, or videos that do not align with platform policies, as it ensures a more nuanced understanding of content beyond just visual or textual cues.

Historically, multimodal modeling has been approached using modality-specific architectures that are commonly employed for text and vision tasks (e.g., BERT, ROBERTa, ResNet, and ViT). Multi-modal learning models (e.g., CLIP and GLIP) have effectively combined visual and textual inputs, thereby leveraging correlations between modalities to achieve classification and detection results. However, these models typically require extensive task-specific fine-tuning and are limited by the rigid nature of their underlying architectures. As such, these models are highly specialized for narrow tasks and lack generalizability to unseen problems or broader domains without significant retraining.

Generative multimodal models (e.g., Flamingo, OpenFlamingo, LLaVa, InstructBLIP, and GPT-40) have the ability to perform classic tasks like recognition and detection, as well as being adaptable to a wide range of tasks with minimal task-specific data, often through one-shot or few-shot learning. Their large-scale pretraining on diverse datasets provides them with broad, generalized knowledge that can be flexibly adapted to a range of problems, including those that involve multimodal inputs. As such, generative multimodal models offer an alternative solution for problems traditionally addressed by multimodal architectures, where the challenge lies in understanding video content through a combination of visual, auditory, and sometimes textual cues. However, because these models are typically pretrained on massive public datasets, entity-specific data, such as multimodal data related to proprietary video content, is rarely seen during pretraining. As such, generative multimodal models may struggle to capture the nuances of these specific tasks without further tuning.

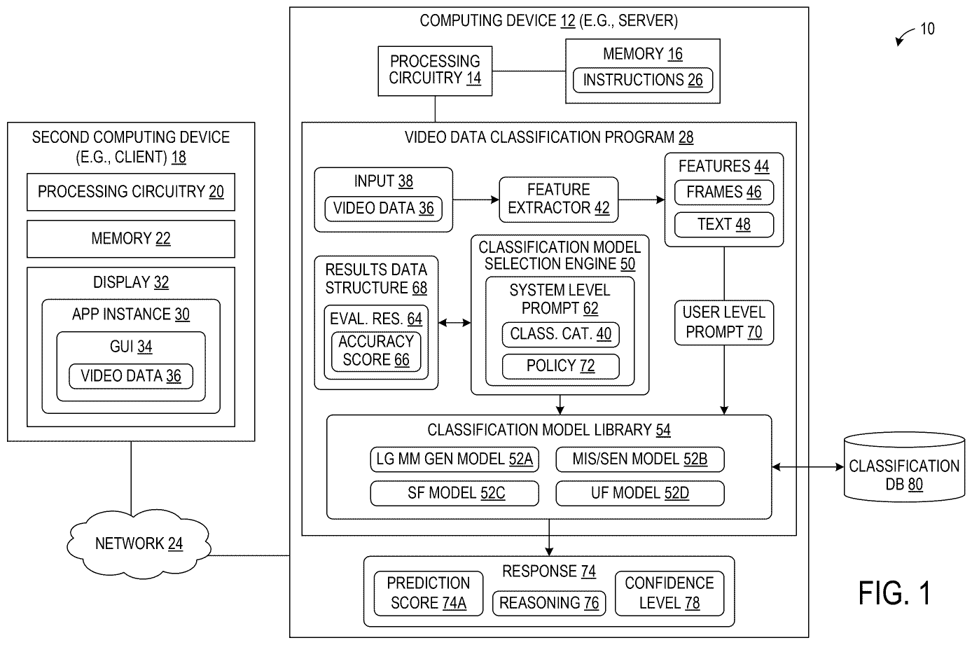

As schematically illustrated in FIG. 1, to address the above identified issues, a computing system 10 for multimodal classification of video data is provided. The computing system 10 is illustrated as comprising a first computing device 12 including processing circuitry 14 and memory 16, and a second computing device 18 including processing circuitry 20 and memory 22, with the first and second computing devices 12, 18 being in communication with one another via a network 24. The illustrated implementation is exemplary in nature, and other configurations are possible. In the description of FIG. 1 below, the first computing device will be described as a server computing device 12 and the second computing device will be described as a client computing device 18, and respective functions carried out at each device will be described. It will be appreciated that in other configurations, the first computing device could be a computing device other than server computing device 12, such as an intermediate networking device such as a router, gateway, load balancer, firewall, etc. In some configurations, the computing system 10 may include a single computing device that carries out the salient functions of both the server computing device 12 and test computing device 18. In other alternative configurations, functions described as being carried out at the client computing device 18 may alternatively be carried out at the server computing device 12 and vice versa.

Continuing with FIG. 1, the server computing device 12 may, for example, take the form of a server provisioned in a data center, for example. As discussed above, the server computing device 12 includes processing circuitry 14 and associated memory 16. The processing circuitry 14 is configured to execute instructions 26 using portions of the associated memory 16 to implement a video data classification program 28, which is in turn configured to perform classification tasks in a plurality of classification categories.

FIG. 1 shows the computing system during an inference phase. In an example embodiment, a user launches an application instance 30, such as an online video platform, which is then displayed on a display 32 of the client computing device 18. The application instance 30 includes a graphical user interface 34 by which the user can upload video data 36, such as user-generated video data. Attempting to upload the video data 36 to the online video platform triggers execution of the video data classification program 28 to determine if the video data 36 satisfies platform policies, such as being of sufficiently high quality, etc. Specific examples of classification categories and policies are discussed below. Accordingly, the video data 36 is transmitted to the server computing device 12 via the network 24 and received as input 38 to be classified by the video data classification program 28, according to a selected classification category 40 for classifying video data content.

The selected classification category 40 is selected from the group consisting of non-interactive duet 40A, misleading and/or sensationalized 40B, static frame 40C, watermark 40D, and usefulness 40E, for example. Brief descriptions of the example classification categories 40 described herein are as follows:
Non-interactive duet: two or more content modules appear in one video, but there is not communication, connection, or mutual response between them.
Misleading and/or sensationalized: the video content entices viewers to interact with the video to achieve a higher number of viewer engagements.
Static frame: the file is in a video format, but the content is completely static, e.g., pictures, solid color, screenshots.
Watermark: the video includes watermarks of other applications and/or social media platforms.
Usefulness: the video content conveys knowledge, experience, and information that help viewers learn more about a topic.

It will be appreciated that the described classification categories are not intended to be limiting, and the computing system 10 for multimodal classification of video data and the video data classification program 28 may be implemented with additional or alternative classification categories that are not described herein.

A feature extractor 42 included in the video data classification program 28 extracts features 44, such as a plurality of frames 46 and corresponding text features 48 from the video data 36. The plurality of frames 46 are extracted in a sequence at a rate of one frame every two seconds and include the first and last frames, for example. The text features 48 includes a title and a sticker, such as the username of the user.

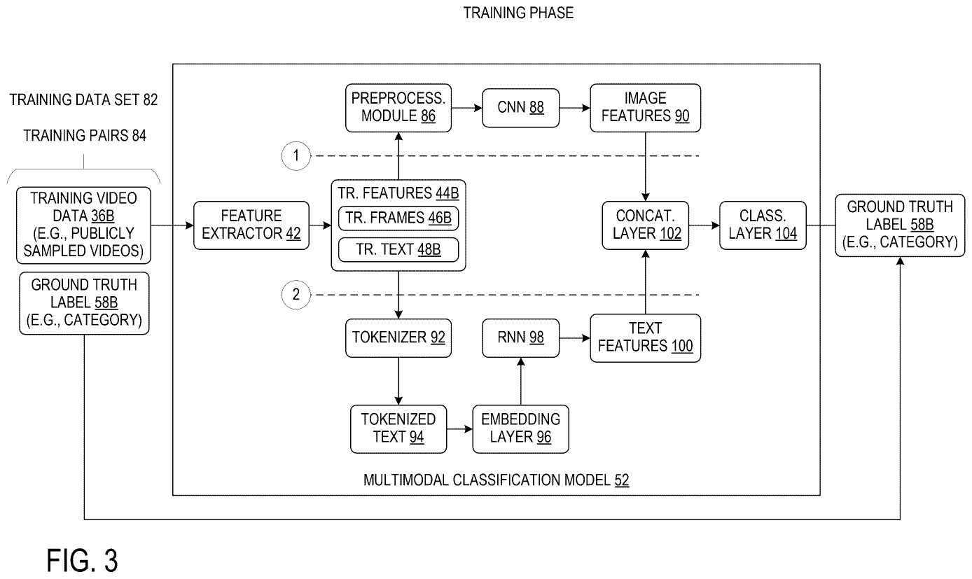

A classification model selection engine 50 is implemented to select a multimodal classification model 52 from a library 54 of multimodal classification models based on the selected classification category 40. The library 54 of multimodal classification models includes at least one large multimodal generative model 52A, and the library 54 may further include other models 52B, 52C, 52D that are not multimodal generative models, but are instead proprietary models trained on training data sets for respective classification categories, as discussed in detail below with reference to FIG. 3. While the multimodal classification models 52B, 52C, 52D are indicated to be associated with the classification categories misleading and/or sensationalized, static frame, and usefulness, respectively, it will be appreciated that the models may be trained for more than one classification category, and/or for classification categories that are not described herein.

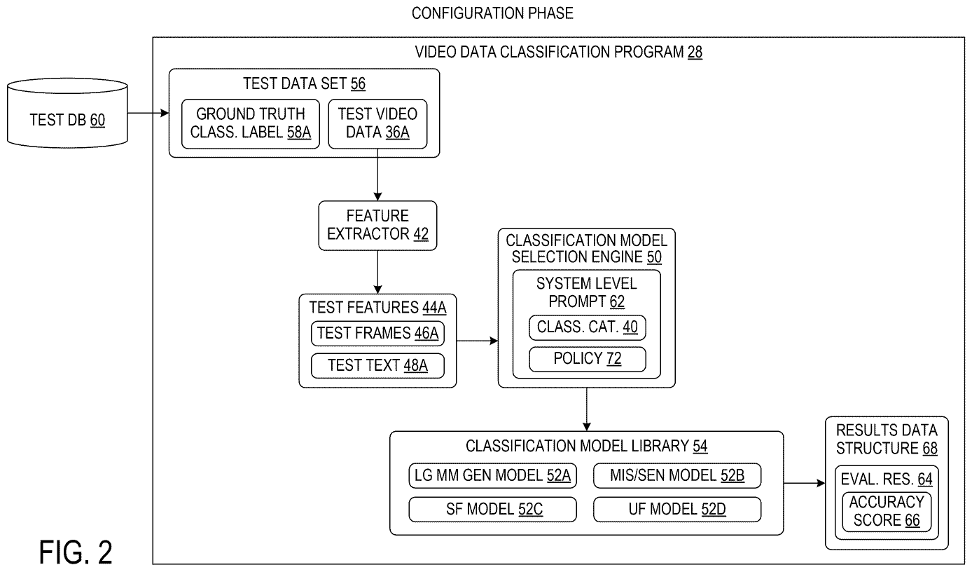

Turning briefly to FIG. 2, in a configuration phase prior to the inference phase, the classification model selection engine 50 is configured to perform an evaluation of performance of each of the multimodal classification models 52A, 52B, 52C, 52D in each of the plurality of classification categories 40A, 40B, 40C, 40D, 40E. The evaluation uses corresponding test data sets 56 that include test video data 36A labeled with ground truth classification labels 58A for each of the classification categories 40A, 40B, 40C, 40D, 40E. The test video data 36A includes at least 500 video posts (i.e., user-generated video data). The associated ground truth classification labels 58A is provided by trained human annotators, in compliance with platform policies defining each classification category. The test data sets 56 are stored in a test database 60. Test features 44A, including a plurality of test frames 46A and corresponding test text features 48A, are extracted from the test video data 36A by the feature extractor 42.

To evaluate the performance of each of the multimodal classification models 52A, 52B, 52C, 52D for each of the plurality of classification categories 40A, 40B, 40C, 40D, 40E, the classification model selection engine 50 prompts each of the multimodal classification models in turn to classify the extracted test features 44A according to each of the classification categories. For example, the classification model selection engine 50 inputs the test features 44A into the large multimodal generative model 52A, and additionally queries the model 52A with a system level prompt 62 to classify the plurality of test frames 46A and test text features 48A according to non-interactive duet 40A content. The system level prompt 62 includes a detailed text policy 72 that defines criteria by which content is analyzed for the classification category 40A. The evaluation results 64, including an accuracy score 66, from this first evaluation of performance are stored in a results data structure 68, such as a file or a database, for later retrieval during the inference phase. The classification model selection engine 50 then proceeds to query the model 52A with a system level prompt 62 for classifying the test features 44A in accordance with misleading and/or sensationalized 40B content, for example, continuing the performance evaluation until each of the multimodal classification models 52A, 52B, 52C, 52D has been evaluated for each of the plurality of classification categories 40A, 40B, 40C, 40D, 40E, and the evaluation results 64 and accuracy scores 66 for each evaluation are stored in the results data structure 68.

Returning to FIG. 1, to select a multimodal classification model 52 from the library 54 of multimodal classification models, the classification model selection engine 50 reads the evaluation results 64 stored in the results data structure 68 and selects the multimodal classification model 52 by choosing a multimodal classification model having a highest accuracy score 66 according to the evaluation results 64 for the selected classification category 40. The selected multimodal classification model 52 is queried with a prompt 70 to classify the plurality of frames 46 and the corresponding text features 48 according to the selected classification category 40. The prompt 70 is input to the selected multimodal classification model 52, along with the plurality of frames 46 and the corresponding text features 48.

An example prompt 70 is as follows:
“Given a video with the following features: audio transcription, hashtag, text, sticker text, and video frames, classify the content of the video according to {the selected classification category}. Format your output as a JSON object with the specified keys.”

The prompt 70 may be a user level prompt, and the selected multimodal classification model 52 is additionally queried with at least one system level prompt 62 concurrent with or prior to the user level prompt 70. As discussed above with reference to FIG. 2, the system level prompt 62 includes a detailed text policy 72 that defines criteria by which content is analyzed for the classification category.

An example system level prompt 62 is as follows:
“Your task is to video data for {the selected classification category} content. You are required to classify videos based on if they contain {the selected classification category} content. The classification will help in training models to identify {the selected classification category} content. The video data should be labeled with an associated score indicating the likelihood of the video data including {the selected classification category} content based on the policy associated with {the selected classification category}.”

### {Policy}

“For the video data, output a clear reasoning behind your decision and a score indicating the overall likelihood of the video including {the selected classification category} content. Format your output as a JSON object with the following keys:
   reasoning: a chain of reasoning that explains how you arrived at your classification;
   score: an integer score from 0 to 100 representing how likely it is that the video is {the selected classification category} content, with 100 indicating that the video certainly is {the selected classification category} content, and 0 indicating that you are confident this is not {the selected classification category}.

Be clear and specific in your classification. Inspect every frame provided. Use the detailed policy to guide your judgment.”

In response to receiving both the system level prompt 62 and the user level prompt 70, the selected multimodal classification model 52 inspects each frame in the plurality of frames 46 and corresponding text features 48 in accordance with the selected classification category 40 and the corresponding policy 72.

Example policies 72 for each classification categories 40 are as follows:
Non-interactive duet policy: Two or more content modules appear in one video, but there is no interaction or thematic connection between them. The modules may appear as split screen visuals, juxtaposed scenes, or overlayed visuals, e.g., a person or object on top of a video. There is no real communication, connection, or mutual response between them during the performance. They may simply carry out their individual parts independently without significant interplay or engagement with each other, lacking any obvious interaction or collaboration in terms of expressions, gestures, or exchanges.
Misleading and/or sensationalized policy: The video content entices viewers to interact with the video to artificially increase viewer engagement metrics and gain more distribution and traffic than they would without such tactics. Indicators for this category usually appear in the videos, sticker texts, captions, audios, and sometimes in the comment or song names. Subcategories of misleading and/or sensationalized video content are shown in Table 1.

TABLE 1
Subcategories of misleading and/or sensationalized video content

| Type | Description and Examples |
|---|---|
| Vote/Choose | Asking viewers or their friends to vote or choose. |
| | Examples: Showing a list of options (1, 2, 3) and asking users to pick, |
| | prompting viewers to ask friends about a topic |
| Misleading/ | Interaction through misleading practices. |
| Deceptive | Examples: Offering money for special effects, deceptive “wait until the |
| | end” with no payoff, irrelevant asks for comment, like, or share. |
| Gifts/ | Offering gifts or benefits to prompt interaction. |
| Benefits | Examples: “Type ‘lol’ in the comments for a special emoji,” |
| | “Like this video to win a prize.” |
| Social | Leveraging social attributes to encourage interaction. |
| | Examples: “Tag your best friend,” “Send this to your friends.” |
| Game/Test | Interaction through games, tests, or quizzes with bait indicators. |
| | Example: “Comment how many you got correct.” |
| Straightforward | Direct requests for interaction using prompts, arrows, or icons. |
| Interaction | Examples: “Follow me for part 2,” use of hashtags: #like #follow. |
| Others | Any other manipulative tactics not covered in other categories. |
| | Example: Reverse psychology like “Don't follow, don't share.” |
| Suspected | No indicators, but suspected to artificially increase engagement metrics |
| | and get more distribution and traffic than they honestly would. |

Static frame policy: The file appears to be in a video format, but the content comprises static pictures, solid color, and/or screenshots.
Watermark policy: One or more frames include watermarks from other social media platforms, photo and video editing software and apps, video and audio sharing/playing platforms, social communication software and apps, live streaming platforms, and/or screen recording software and apps. Pay close attention to the following details: watermarks can appear at the beginning, throughout, or towards the end of the video; logos can be located on any part of the frame, including edges, corners, or the center of the frame; scrutinize all pixels of the frame for any such indications that the video includes watermarks of other applications and/or social media platforms.
Usefulness policy: Useful content is information that enriches users by providing them with knowledge, aiding in problem-solving, and increasing awareness of the world. It encompasses:
1. Knowledge content: Sharing of expertise across various disciplines such as sciences, humanities, and arts to impart valuable knowledge.
2. Experience content: Sharing personal or third-party experiences that offer practical skills, advice, inspiration, or comfort to help users in their daily lives, careers, and personal growth.
3. Information content:
   (a) News content: Timely updates and announcements that keep users informed about global and local events.
   (b) Enlightening content: Material that raises awareness on less-discussed topics like mental health or social issues, and opinion pieces that present reasoned arguments on current affairs, promoting exposure to diverse perspectives.

Upon completion of inspecting each frame in the plurality of frames 46 and corresponding text features 48 in accordance with the selected classification category 40 and the corresponding policy 72, the selected multimodal classification model 52 outputs a response 74. As discussed above with respect to the system level prompt 62 and the user level prompt 70, the response 74 including a prediction score 74A indicating a likelihood that the plurality of frames 46 and the corresponding text features 48 includes content in the selected classification category 40. The prediction score 74A is an integer in a range of 0 to 100, and the response 74 further includes a chain of reasoning 76 for the prediction score 74A. When the selected multimodal classification model 52 is the at least one large multimodal generative model 52A, the response 74 further includes a confidence level 78 with regard to an accuracy of the prediction score 74A. The response 74 may be output to the client computing device 18 and displayed in the GUI 34 of the application instance 30. Additionally or alternatively, the response 74 may be stored in a classification database 80 such that it may be used for finetuning the selected classification model 52 and/or as test data sets 56, upon human annotation with a ground truth label.

When the prediction score 74A is above a predetermined threshold value indicating that the video data 36 includes content in the selected classification category 40, a predefined action can be taken such as flagging the video data 36 for review, preventing the video data 36 from being published to users of a video sharing platform, blocking the video data 36 from being uploaded to the video sharing platform, etc. The classification can also be a positive classification of video data 36 that is to be promoted or encouraged on the platform, such as high quality or professionally produced video data. In such cases the predefined action can be to enable upload, enable publishing, flag for promotion, or other action that promotes the viewership of the video data 36. In yet other case the classification can be one used for diagnostic purposes, and the predefined action can be a log action to log the classification result.

FIG. 3 shows a schematic view of a training phase for the multimodal classification models. As discussed above with reference to FIG. 1, multimodal classification models 52B, 52C, 52D are proprietary models trained on training data sets for respective classification categories. For example, the multimodal classification models 52B, 52C, 52D may be in-house classification models that leverage multimodal features to classify video data. It will be appreciated that the large multimodal generative model 52A may be implemented without further training, or it may be finetuned with training data sets.

As illustrated in FIG. 3, the training data sets 82 include training pairs 84 for respective classification categories of the plurality of classification categories. The training pairs include training video data 36B, such as publicly sampled video data, and ground truth labels 58B. The ground truth labels 58B may be human-annotated label that indicate whether the training video data 36B contains content that corresponds to the respective classification category.

The multimodal classification models 52B, 52C, 52D may be configured as fusion models, joint embedding models, transformer-based multimodal models, recurrent or sequential models, or graph neural networks, for example. Each of the multimodal classification models 52B, 52C, 52D may be configured similarly or independently of one another. In the example training phase describe herein, the multimodal classification model 52 is configured as a fusion model that implements different neural networks to separately process the multiple modalities of the input data. The training frames 46B are processed separately from the corresponding training text features 48B, as indicated by 1 and 2, respectively, as indicated in FIG. 3.

As described above with respect to the inference phase in FIG. 1 and the configuration phase in FIG. 2, the feature extractor 42 extracts training features 44B from the training video data 36B, including a plurality of training frames 46B and corresponding training text features 48B. The plurality of training frames 46B are preprocessed at a preprocessing module 86 to resize and normalize the frames to maintain uniformity across the plurality of training frames 46B. A convolutional neural network (CNN) 88 is then implemented to extract image features 90 from the training frames 46B. The CNN 88 may be a pre-trained CNN or a custom-trained CNN, for example. In some embodiments, the CNN 88 may output feature vectors representing the image features 90. Alternatively, the final layer of the CNN 88 may be removed such that embeddings may be used as image features 90.

The corresponding training text features 48B are preprocessed at a tokenizer 92, which removes unnecessary characters, converts the letters to lowercase, and outputs tokenized text 94. The tokenized text 94 is then represented as embeddings via an embedding layer 96. The embeddings are input to a recurrent neural network (RNN) 98, and text features 100 are extracted from the embeddings.

The image features 90 from the CNN 88 and the text features 100 from the RNN 98 are then concatenated via a concatenation layer 102. A fully connected layer or attention mechanisms may be used to weigh important modalities. Additionally or alternatively, cross-modal transformers can be used for joint attention. The fused features are then input to a classification layer 104, such as a fully connected neural network, and classified according to a specified classification category 40. It will be appreciated that the classification layer 104 serves as the output layer for the example fusion-based multimodal classification model. The output may be compared to the ground truth label 58B, and a loss function may be applied to compute the loss. The computed loss may be backpropagated through the model to adjust weights in the concatenation layer 102 and/or in the CNN 88 and the RNN 98.

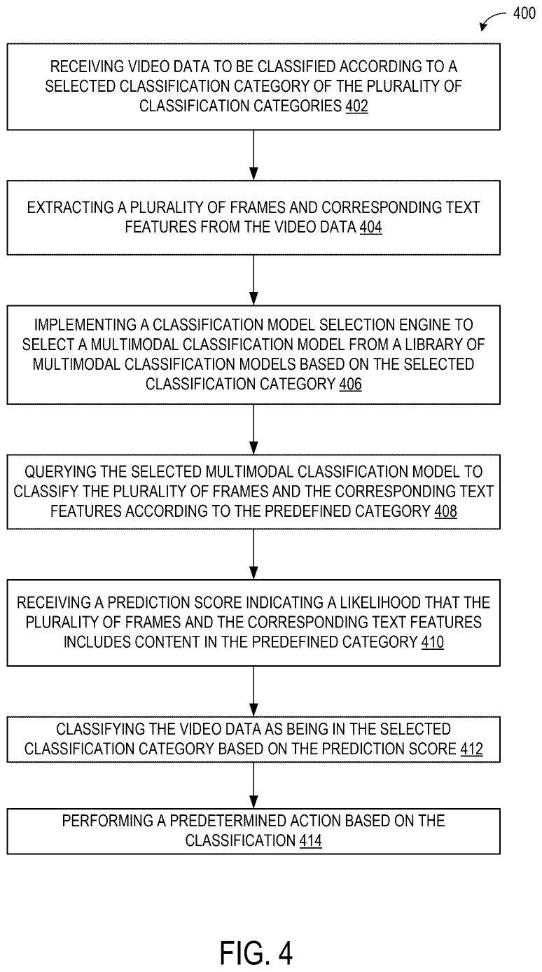

FIG. 4 shows a flowchart for a method 400 for multimodal classification of video data. The method 400 may be implemented by the computing system 10 illustrated in FIG. 1, or via other suitable hardware and software. It will be appreciated that the method 400 is implemented in an inference phase.

At step 402, the method 400 may include receiving video data to be classified according to a selected classification category of the plurality of classification categories. As described herein, the selected classification category may be selected from the group consisting of non-interactive duet, misleading and/or sensationalized, static frame, watermark, and usefulness.

Continuing from step 402 to step 404, the method 400 may include extracting a plurality of frames and corresponding text features from the video data. The plurality of frames may be extracted in a sequence at a rate of one frame every two seconds. The sequence of extracted frames may include the first frame and the last frame, regardless of the length of the video data.

Proceeding from step 404 to step 406, the method 400 may include implementing a classification model selection engine to select a multimodal classification model from a library of multimodal classification models based on the selected classification category. The library of multimodal classification models may include at least one large multimodal generative model.

In a training phase, the method 400 may include training one or more multimodal classification models in the library of multimodal classification models on training data sets that include training pairs for respective classification categories of the plurality of classification categories. The training pairs may include publicly sampled video data and human-annotated ground truth labels. In a configuration phase prior to the inference phase, the method 400 may include performing an evaluation of performance of each of the multimodal classification models in each of the plurality of classification categories, and storing the evaluation results in a results data structure. In the inference phase, the method 400 may include reading the evaluation results stored in the results data structure and selecting the multimodal classification model having a highest accuracy score according to the evaluation results for the selected classification category.

Advancing from step 406 to step 408, the method 400 may include querying the selected multimodal classification model with a prompt to classify the plurality of frames and the corresponding text features according to the selected classification category. The prompt to classify the plurality of frames and the corresponding text features according to the selected classification category may be a user level prompt, and the selected multimodal classification model may be queried with at least one system level prompt to classify the plurality of frames and the corresponding text features according to the selected classification category. The at least one system level prompt may include a detailed text policy that defines criteria by which content is analyzed in the respective classification category and instruct the selected multimodal classification model to inspect each frame in the sequence.

Continuing from step 408 to step 410, the method 400 may include receiving a response from the selected multimodal classification model. The response may include a prediction score indicating a likelihood that the plurality of frames and the corresponding text features includes content in the selected classification category. The response may further include a chain of reasoning for the prediction score that is formatted as an integer in a range of 0 to 100. When the selected multimodal classification model is the at least one large multimodal generative model, the response may include a confidence level with regard to an accuracy of the prediction score. When the prediction score is above a predetermined threshold indicating that the user-generated video data includes content in the selected classification category, the user-generated video data may be blocked from being uploaded to the online video platform.

At 412, the method 400 includes classifying the video data as being in the selected classification category based on the prediction score, such as when the prediction score is above a threshold as described in the preceding paragraph. At 414, the method includes performing a predetermined action based on the classification of the video data as being in the selected classification category. Example predetermined actions are described above.

In this manner, a multimodal classification model that is appropriate for an inference task, both in terms of accuracy and efficiency, may be selected prior to performing inference. This promotes enhanced accuracy of inference results, as well as efficient use of computation resources, by avoiding use of inaccurate models. Further, the downstream effects that result from performing accurate classification can have beneficial effects on the quality of service that an entity provides, such as by improving the quality of videos available for viewing on a video sharing platform.

In some embodiments, the methods and processes described herein may be tied to a computing system of one or more computing devices. In particular, such methods and processes may be implemented as a computer-application program or service, an application-programming interface (API), a library, and/or other computer-program product.

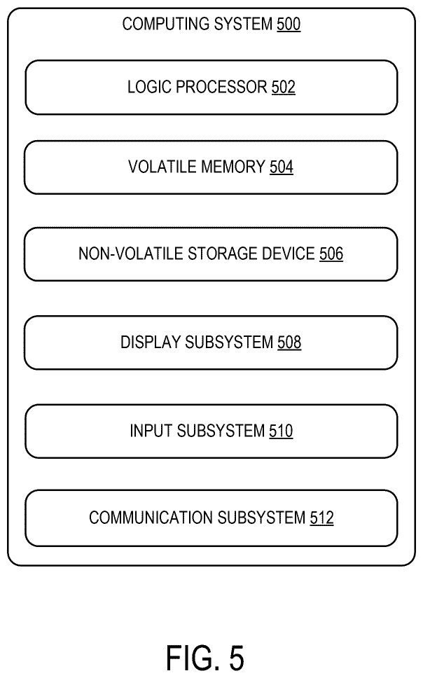

FIG. 5 schematically shows a non-limiting embodiment of a computing system 500 that can enact one or more of the methods and processes described above. Computing system 500 is shown in simplified form. Computing system 500 may embody the computer devices 12, 18 described above and illustrated in FIG. 1. Computing system 500 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 500 includes a logic processor 502 volatile memory 504, and a non-volatile storage device 506. Computing system 500 may optionally include a display subsystem 508, input subsystem 510, communication subsystem 512, and/or other components not shown in FIG. 5.

Logic processor 502 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 502 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 506 includes one or more physical devices configured to hold instructions executable by the logic processors to implement the methods and processes described herein. When such methods and processes are implemented, the state of non-volatile storage device 506 may be transformed—e.g., to hold different data.

Non-volatile storage device 506 may include physical devices that are removable and/or built-in. Non-volatile storage device 506 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 506 may include nonvolatile, dynamic, static, read/write, read-only, sequential-access, location-addressable, file-addressable, and/or content-addressable devices. It will be appreciated that non-volatile storage device 506 is configured to hold instructions even when power is cut to the non-volatile storage device 506.

Volatile memory 504 may include physical devices that include random access memory. Volatile memory 504 is typically utilized by logic processor 502 to temporarily store information during processing of software instructions. It will be appreciated that volatile memory 504 typically does not continue to store instructions when power is cut to the volatile memory 504.

Aspects of logic processor 502, volatile memory 504, and non-volatile storage device 506 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 500 typically implemented in software by a processor to perform a particular function using portions of volatile memory, which function involves transformative processing that specially configures the processor to perform the function. Thus, a module, program, or engine may be instantiated via logic processor 502 executing instructions held by non-volatile storage device 506, using portions of volatile memory 504. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 508 may be used to present a visual representation of data held by non-volatile storage device 506. The visual representation may take the form of a graphical user interface (GUI). As the herein described methods and processes change the data held by the non-volatile storage device, and thus transform the state of the non-volatile storage device, the state of display subsystem 508 may likewise be transformed to visually represent changes in the underlying data. Display subsystem 508 may include one or more display devices utilizing virtually any type of technology. Such display devices may be combined with logic processor 502, volatile memory 504, and/or non-volatile storage device 506 in a shared enclosure, or such display devices may be peripheral display devices.

When included, input subsystem 510 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 512 may be configured to communicatively couple various computing devices described herein with each other, and with other devices. Communication subsystem 512 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 500 to send and/or receive messages to and/or from other devices via a network such as the Internet.

The following paragraphs provide additional description of the subject matter of the present disclosure. One aspect provides a computing system for multimodal classification of video data. The computing system may comprise a computing device including processing circuitry that is configured to execute instructions using portions of associated memory to implement a video data classification program. The video data classification program may be configured to perform classification tasks in a plurality of classification categories. In an inference phase, the processing circuitry may be configured to receive video data to be classified according to a selected classification category of the plurality of classification categories, extract a plurality of frames and corresponding text features from the video data, implement a classification model selection engine to select a multimodal classification model from a library of multimodal classification models based on the selected classification category, query the selected multimodal classification model with a prompt to classify the plurality of frames and the corresponding text features according to the selected classification category, and receive a response from the selected multimodal classification model, the response including a prediction score indicating a likelihood that the plurality of frames and the corresponding text features includes content in the selected classification category.

In this aspect, additionally or alternatively, the classification model selection engine may be configured to, in a configuration phase prior to the inference phase, perform an evaluation of performance of each of the multimodal classification models in each of the plurality of classification categories. The evaluation of performance may use corresponding test data sets that include test video data labeled with ground truth classification labels for each of the classification categories, and the test video data may include a plurality of test frames and corresponding test text features. The classification model selection engine may be further configured to store evaluation results of the evaluation of performance in a results data structure for later retrieval during the inference phase, and the evaluation results may include an accuracy score. In the inference phase, the classification model selection engine may be configured to read the evaluation results stored in the results data structure and select the multimodal classification model from the library of multimodal classification models by choosing a multimodal classification model having a highest accuracy score according to the evaluation results for the selected classification category.

In this aspect, additionally or alternatively, the prompt to classify the plurality of frames and the corresponding text features according to the selected classification category may be a user level prompt, and the selected multimodal classification model may be additionally queried with at least one system level prompt to classify the plurality of frames and the corresponding text features according to a detailed text policy that defines criteria by which content is analyzed in the selected classification category.

In this aspect, additionally or alternatively, the selected classification category may be selected from the group consisting of non-interactive duet, misleading and/or sensationalized, static frame, watermark, and usefulness.

In this aspect, additionally or alternatively, the response may further include a chain of reasoning for the prediction score, and the prediction score may be an integer in a range of 0 to 100.

In this aspect, additionally or alternatively, the plurality of frames may be extracted in a sequence, and the selected multimodal classification model may inspect each frame in the sequence.

In this aspect, additionally or alternatively, the library of multimodal classification models may include at least one large multimodal generative model.

In this aspect, additionally or alternatively, when the selected multimodal classification model is the at least one large multimodal generative model, the response may further include a confidence level with regard to an accuracy of the prediction score.

In this aspect, additionally or alternatively, one or more multimodal classification models in the library of multimodal classification models may be trained on training data sets that include training pairs for respective classification categories of the plurality of classification categories.

In this aspect, additionally or alternatively, the training pairs may include publicly sampled video data and human-annotated ground truth labels.

Another aspect provides a method for multimodal classification of video data. In an inference phase, the method may comprise receiving video data to be classified according to a selected classification category of the plurality of classification categories, extracting a plurality of frames and corresponding text features from the video data, implementing a classification model selection engine to select a multimodal classification model from a library of multimodal classification models based on the selected classification category, querying the selected multimodal classification model with a prompt to classify the plurality of frames and the corresponding text features according to the selected classification category, and receiving a response from the selected multimodal classification model, the response including a prediction score indicating a likelihood that the plurality of frames and the corresponding text features includes content in the selected classification category.

In this aspect, additionally or alternatively, the method may further comprise, in a configuration phase prior to the inference phase, performing an evaluation of performance of each of the multimodal classification models in each of the plurality of classification categories, using corresponding test data sets that include test video data labeled with ground truth classification labels for each of the classification categories, the test video data including frames and text features, and storing evaluation results of the evaluation of performance in a results data structure for later retrieval during the inference phase, the evaluation results including an accuracy score. In the inference phase, the method may comprise reading the evaluation results stored in the results data structure, and selecting the multimodal classification model from the library of multimodal classification models by choosing a multimodal classification model having a highest accuracy score according to the evaluation results for the selected classification category.

In this aspect, additionally or alternatively, the prompt to classify the plurality of frames and the corresponding text features according to the selected classification category may be a user level prompt, and the method may further comprise querying the selected multimodal classification model with at least one system level prompt to classify the plurality of frames and the corresponding text features according to a detailed text policy that defines criteria by which content is analyzed in the respective classification category.

In this aspect, additionally or alternatively, the selected classification category may be selected from the group consisting of non-interactive duet, misleading and/or sensationalized, static frame, watermark, and usefulness.

In this aspect, additionally or alternatively, the method may further comprise including in the response a chain of reasoning for the prediction score, and formatting the prediction score as an integer in a range of 0 to 100.

In this aspect, additionally or alternatively, the method may further comprise extracting the plurality of frames in a sequence, and inspecting, by the selected multimodal classification model, each frame in the sequence.

In this aspect, additionally or alternatively, the method may further comprise including in the library of multimodal classification models at least one large multimodal generative model.

In this aspect, additionally or alternatively, the method may further comprise, when the selected multimodal classification model is the at least one large multimodal generative model, including in the response a confidence level with regard to an accuracy of the prediction score.

In this aspect, additionally or alternatively, the method may further comprise training one or more multimodal classification models in the library of multimodal classification models on training data sets that include training pairs for respective classification categories of the plurality of classification categories, and the training pairs may include publicly sampled video data and human-annotated ground truth labels.

Another aspect provides a computing system for multimodal classification of user-generated video data. The computing system may comprise a computing device including processing circuitry that is configured to execute instructions using portions of associated memory to implement a video data classification program. The video data classification program may be configured to perform classification tasks in a plurality of classification categories on user-generated video data to be uploaded to an online video platform. In an inference phase, the processing circuitry may be configured to receive user-generated video data to be classified according to a selected classification category of the plurality of classification categories, extract a plurality of frames and corresponding text features from the user-generated video data, implement a classification model selection engine to select a multimodal classification model from a library of multimodal classification models based on the selected classification category, query the selected multimodal classification model with a prompt to classify the plurality of frames and the corresponding text features according to the selected classification category, and receive a response from the selected multimodal classification model, the response including a prediction score indicating a likelihood that the user-generated video data includes content in the selected classification category. When the prediction score is above a predetermined threshold indicating that the user-generated video data includes content in the selected classification category, the user-generated video data may be blocked from being uploaded to the online video platform.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for multimodal classification of video data, the computing system comprising:
a computing device including processing circuitry configured to execute instructions using portions of associated memory to implement a video data classification program configured to perform classification tasks in a plurality of classification categories, wherein the processing circuitry is configured to:
in an inference phase:
receive video data to be classified according to a selected classification category of the plurality of classification categories;
extract a plurality of frames and corresponding text features from the video data;
implement a classification model selection engine to select a multimodal classification model from a library of multimodal classification models based on the selected classification category;
query the selected multimodal classification model with a prompt to classify the plurality of frames and the corresponding text features according to the selected classification category; and
receive a response from the selected multimodal classification model, the response including a prediction score indicating a likelihood that the plurality of frames and the corresponding text features includes content in the selected classification category.

2. The computing system of claim 1, wherein the classification model selection engine is configured to:
in a configuration phase prior to the inference phase:
perform an evaluation of performance of each of the multimodal classification models in each of the plurality of classification categories, using corresponding test data sets that include test video data labeled with ground truth classification labels for each of the classification categories, the test video data including a plurality of test frames and corresponding test text features; and
store evaluation results of the evaluation of performance in a results data structure for later retrieval during the inference phase, the evaluation results including an accuracy score, and
in the inference phase:
read the evaluation results stored in the results data structure; and
select the multimodal classification model from the library of multimodal classification models by choosing a multimodal classification model having a highest accuracy score according to the evaluation results for the selected classification category.

3. The computing system of claim 1, wherein
the prompt to classify the plurality of frames and the corresponding text features according to the selected classification category is a user level prompt, and
the selected multimodal classification model is additionally queried with at least one system level prompt to classify the plurality of frames and the corresponding text features according to a detailed text policy that defines criteria by which content is analyzed in the selected classification category.

4. The computing system of claim 1, wherein
the selected classification category is selected from the group consisting of non-interactive duet, misleading and/or sensationalized, static frame, watermark, and usefulness.

5. The computing system of claim 1, wherein
the response further includes a chain of reasoning for the prediction score, and
the prediction score is an integer in a range of 0 to 100.

6. The computing system of claim 1, wherein
the plurality of frames is extracted in a sequence, and
the selected multimodal classification model inspects each frame in the sequence.

7. The computing system of claim 1, wherein
the library of multimodal classification models includes at least one large multimodal generative model.

8. The computing system of claim 7, wherein
when the selected multimodal classification model is the at least one large multimodal generative model, the response further includes a confidence level with regard to an accuracy of the prediction score.

9. The computing system of claim 1, wherein
one or more multimodal classification models in the library of multimodal classification models are trained on training data sets that include training pairs for respective classification categories of the plurality of classification categories.

10. The computing system of claim 9, wherein
the training pairs include publicly sampled video data and human-annotated ground truth labels.

11. A method for multimodal classification of video data, the method comprising:
in an inference phase:
receiving video data to be classified according to a selected classification category of a plurality of classification categories;
extracting a plurality of frames and corresponding text features from the video data;
implementing a classification model selection engine to select a multimodal classification model from a library of multimodal classification models based on the selected classification category;
querying the selected multimodal classification model with a prompt to classify the plurality of frames and the corresponding text features according to the selected classification category; and
receiving a response from the selected multimodal classification model, the response including a prediction score indicating a likelihood that the plurality of frames and the corresponding text features includes content in the selected classification category.

12. The method of claim 11, the method further comprising:
in a configuration phase prior to the inference phase:
performing an evaluation of performance of each of the multimodal classification models in each of the plurality of classification categories, using corresponding test data sets that include test video data labeled with ground truth classification labels for each of the classification categories, the test video data including frames and text features; and
storing evaluation results of the evaluation of performance in a results data structure for later retrieval during the inference phase, the evaluation results including an accuracy score, and
in the inference phase:
reading the evaluation results stored in the results data structure; and
selecting the multimodal classification model from the library of multimodal classification models by choosing a multimodal classification model having a highest accuracy score according to the evaluation results for the selected classification category.

13. The method of claim 11, wherein
the prompt to classify the plurality of frames and the corresponding text features according to the selected classification category is a user level prompt, and
the method further comprises:
querying the selected multimodal classification model with at least one system level prompt to classify the plurality of frames and the corresponding text features according to a detailed text policy that defines criteria by which content is analyzed in a respective classification category.

14. The method of claim 11, wherein
the selected classification category is selected from the group consisting of non-interactive duet, misleading and/or sensationalized, static frame, watermark, and usefulness.

15. The method of claim 11, the method further comprising:
including in the response a chain of reasoning for the prediction score, and
formatting the prediction score as an integer in a range of 0 to 100.

16. The method of claim 11, the method further comprising:
extracting the plurality of frames in a sequence, and
inspecting, by the selected multimodal classification model, each frame in the sequence.

17. The method of claim 11, the method further comprising:
including in the library of multimodal classification models at least one large multimodal generative model.

18. The method of claim 17, the method further comprising:
when the selected multimodal classification model is the at least one large multimodal generative model, including in the response a confidence level with regard to an accuracy of the prediction score.

19. The method of claim 11, the method further comprising:
training one or more multimodal classification models in the library of multimodal classification models on training data sets that include training pairs for respective classification categories of the plurality of classification categories, wherein
the training pairs include publicly sampled video data and human-annotated ground truth labels.

20. A computing system for multimodal classification of user-generated video data, the computing system comprising:
a computing device including processing circuitry configured to execute instructions using portions of associated memory to implement a video data classification program configured to perform classification tasks in a plurality of classification categories on user-generated video data to be uploaded to an online video platform, wherein the processing circuitry is configured to:
in an inference phase:
receive user-generated video data to be classified according to a selected classification category of the plurality of classification categories;
extract a plurality of frames and corresponding text features from the user-generated video data;
implement a classification model selection engine to select a multimodal classification model from a library of multimodal classification models based on the selected classification category;
query the selected multimodal classification model with a prompt to classify the plurality of frames and the corresponding text features according to the selected classification category; and
receive a response from the selected multimodal classification model, the response including a prediction score indicating a likelihood that the user-generated video data includes content in the selected classification category, wherein
when the prediction score is above a predetermined threshold indicating that the user-generated video data includes content in the selected classification category, the user-generated video data is blocked from being uploaded to the online video platform.
